(19) United States
(12) Patent Application Publication
(10) Pub. No.: US 2026/0360761 A1
(43) Pub. Date: Nov. 12, 2026

(54) Battery Assembly

(71) Applicant: Ruchira Dharmasena, Bloomfield Hills, MI (US)

(72) Inventor: Ruchira Dharmasena, Bloomfield Hills, MI (US)

(21) Appl. No.: 19/203,729

(22) Filed: May 9, 2025

(51) Int. Cl. H01M 4/76; H01M 4/75

(52) U.S. Cl. CPC H01M 4/765; H01M 4/75

(57) ABSTRACT

A battery assembly includes a battery case. Anode and cathode main current collecting plates are disposed adjacent a first and second case sides, respectively. Each terminal end is electrically connected to anode and cathode main current collecting plates, respectively. Anode tubes and cathode tubes extend between the anode and cathode main current collecting plates. Each of the plurality of anode tubes is dispersed amongst the plurality of cathode tubes such that at least one of the plurality of anode tubes is disposed adjacent at least one of the plurality of cathode tubes and at least one of the plurality of cathode tubes is disposed adjacent at least one of the plurality of anode tubes. This mutual contact allows the plurality of anode and cathode tubes to react with each other electro-chemically to create an electrical current at the pair of terminal ends.

### BACKGROUND OF THE INVENTION

### 1. Field of the Invention

This invention relates generally to battery assembly. More specifically, the invention relates to a battery assembly including a nonplanar electrode configuration.

### 2. Description of the Related Art

Battery packs used in electric vehicles typically contain lithium-ion cells. Multiple cells are needed in order increase the capacity and voltage which determine the driving range and power of the vehicle

Individual electrodes are planar in configuration and are placed inside a battery cell housing in parallel fashion to maximize the number of electrodes within a battery cell housing. An electrolytic solution is placed between the electrodes to facilitate the ions being generated by the cell. These battery cells are limited in their energy density partly due to the weight of the electrolytes, electro-chemically inactive cell components such as current collectors and other necessary hardware. A major limiting factor of making a high energy density lithium-ion battery cell is the difficulty of processing thicker electrodes. To improve the material loading per unit area and to facilitate newer electrode manufacturing processes such as dry electrode processing, a cellular electrode design for a battery assembly is presented.

### SUMMARY OF THE INVENTION

A battery assembly includes a battery case that extends between a first case side and a second case side. An anode main current collecting plate is disposed adjacent the first case side. A cathode main current collecting plate is disposed adjacent to the second case side. Each of a pair of terminal ends is electrically connected to anode and cathode main current collecting plates, respectively. A plurality of anode tubes extends between the anode and cathode main current collecting plates. A plurality of cathode tubes extends between the anode and cathode main current collecting plates. Each of the plurality of anode tubes is dispersed amongst the plurality of cathode tubes such that at least one of the plurality of anode tubes is disposed adjacent at least one of the plurality of cathode tubes and at least one of the plurality of cathode tubes is disposed adjacent at least one of the plurality of anode tubes. This mutual contact allows the plurality of anode and cathode tubes to react with each other electro-chemically to create an electrical current at the pair of terminal ends.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view, partially cut away, of one embodiment of the battery assembly;

FIG. 2 is an exploded perspective view of an electrode used in the battery assembly of FIG. 1;

FIG. 3 is the electrode of FIG. 2 assembled;

FIG. 4 is a perspective view of a group of electrodes used in the fabrication of the battery assembly;

FIG. 5 is an exploded perspective view of the group of electrodes of FIG. 4 in relation with an anode and a cathode main current collectors;

FIG. 6 is a side view of the electrodes used in the battery assembly;

FIG. 7 is an enlarged view taken from square 7 in FIG. 6;

FIG. 8 is a simplified side view of two electrodes in the battery assembly configured to be a cathode and an anode, respectively; and

FIG. 9 is an end view of the electrodes of FIG. 8.

### DETAILED DESCRIPTION OF EMBODIMENTS OF THE INVENTION

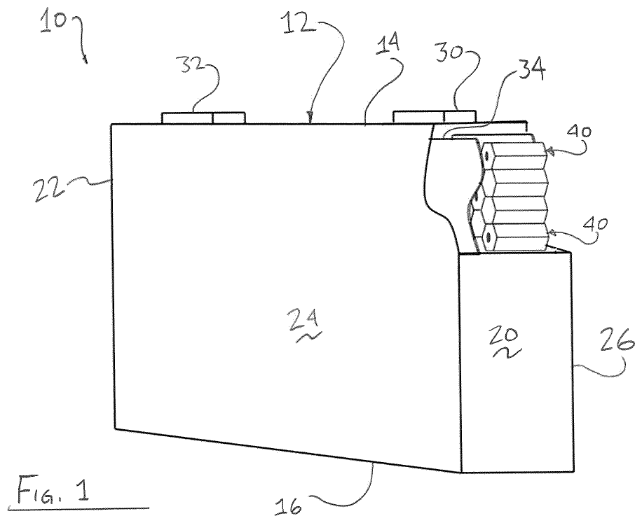

Referring to FIG. 1, a battery assembly is generally indicated at 10. The battery assembly 10 resembles a battery that is typically used in motor vehicles, aircraft, watercraft, and the like. In the embodiment shown, the contents of the battery assembly 10 are void of fluid reservoirs. While the electrodes may be coated with a liquid electrolyte, and any interstitial spaces may be filed with electrolyte (solid or liquid), there are no reservoirs. The contents of the battery assembly 10 will be discussed in greater detail subsequently.

The battery assembly 10 includes a battery case, generally shown at 12. The battery case 12 may be rectangular in shape, having a case top 14, a case bottom 16, two case ends 20, 22. The battery case 12 extends between a first case side 24 and a second case side 26. Two battery terminals 30, 32 extend through the case top 14 and are used to electrically connect the battery assembly 10 to an electrical circuit (not shown). It should be appreciated by those skilled in the art that the battery terminals 30, 32 may extend out from the battery case 12 from any one or more surfaces thereof without adding to the inventive concept.

The battery assembly 10 includes an anode main current collecting plate 36 disposed adjacent the second case side 26. The anode main current collecting plate 36 is fabricated from a ferromagnetic material and extends along much of the second case side 26. The material used to fabricate the anode main current collecting plate 36 is also amenable to having other metal structures welded thereto—these structures will be discussed in greater detail subsequently.

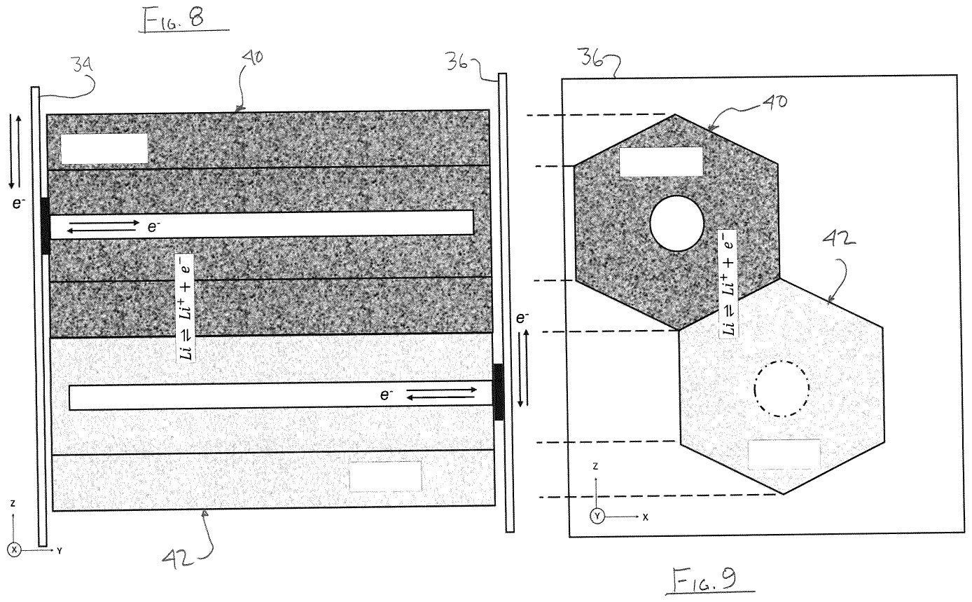

The battery assembly 10 includes a cathode main current collecting plate 34 disposed adjacent the first case side 24. As such, the anode 36 and cathode 34 main current collecting plates are positioned on opposite sides of the battery case 12. The cathode main current collecting plate 34 is fabricated from a ferromagnetic material and extends along much of the first case side 24. The material used to fabricate the cathode main current collecting plate 34 is also amenable to having other metal structures welded thereto. The cathode main current collecting plate 34 is best seen in FIGS. 5 and 8.

Each of the battery terminal ends 30, 32 is connected to one of the anode 36 and cathode 34 main current collecting plates, respectively. The battery terminal end 30 that is connected to the anode main current collecting plate 36 will generally be referred to as the negative terminal, whereas the battery terminal end 32 that is connected to the cathode main current collecting plate 34 will be referred to as the positive terminal.

The battery assembly 10 further includes a plurality of electrodes 40, 42. The plurality of electrodes 40, 42 fill a majority of the space within the batter case 12. The plurality of electrodes 40, 42 are divided into a plurality of cathode tubes 40 and a plurality of anode tubes 42. The number of cathode tubes 40 in relation to the number of anode tubes 42 may be determined by the chemistries of each of the plurality of electrodes 40, 42. In the embodiments shown in the Figures, the chemistries (discussed in greater detail subsequently) require that there are a higher number of anode tubes 42 than cathode tubes 40. It should be appreciated by those skilled in the art that the numbers could equal each other or be the inverse of what is shown solely based on the chemistries of each set of tubes 40, 42.

Expanding on what is described above, each of the plurality of cathode tubes 40 extend between the anode 36 and cathode 34 main current collecting plates. Likewise, each of the plurality of anode tubes 42 extend between the anode and cathode main current collecting plates. Each of the plurality of anode tubes 42 is dispersed amongst the plurality of cathode tubes 40 such that at least one of the plurality of anode tubes 42 is disposed adjacent at least one of the plurality of cathode tubes 40 and at least one of the plurality of cathode tubes 40 is disposed adjacent at least one of the plurality of anode tubes 42. This mutual contact allows the plurality of anode 42 and cathode 40 tubes to react with each other electro-chemically to create an electrical current at the pair of terminal ends.

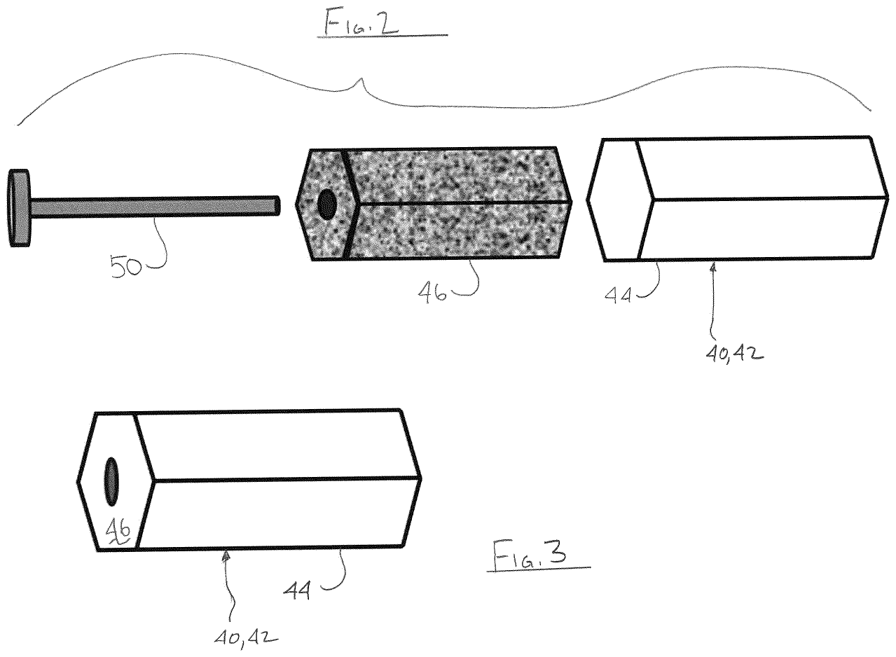

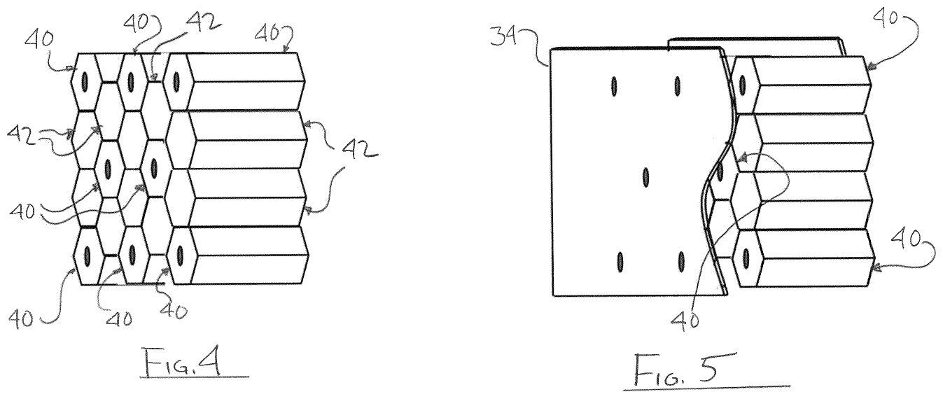

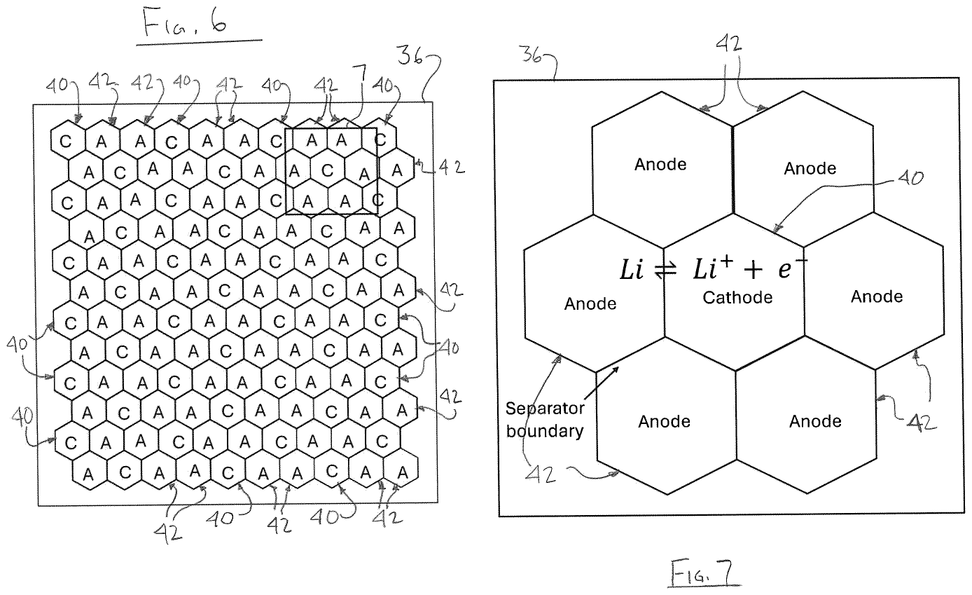

Referring specifically to FIG. 2, one of the plurality of anode 40 and cathode 42 tubes 40 is shown in an exploded view. It should be appreciated by those skilled in the art that the plurality of anode tubes 40 and the plurality of cathode tubes 42 are all fabricated using similar structures. The differences in the materials between the anode tubes 40 and the cathode tubes 42 will be described in greater detail below.

The tubes 40, 42 have an outer layer 44. The outer layer 44 is electrically insulative. The outer layer 44 may be referred to as a separator. The tubes 40, 42 also include a body 46. The body 46 includes a compressed active material, polymer binder and conductive materials such as carbon black. For the cathodes 40, the active material may come from Lithium metal oxides such as LFP, NMCA and LMR. For the anodes 42, the active material used to fabricate the body may come from a group of materials that include graphite, metallic lithium together with binder and conductive material. And finally, each of the tubes 40, 42 includes a current collector pin 50 that extend through at least a portion of each of the tubes 40, 42 through the center thereof. The current collector pin 50 collects electrons and provides a path for those electrons to travel to the terminals 30, 32 via the cathode 34 and anode 36 current collecting plates.

The outer layers 44 and the bodies 46, regardless of whether the body 46 is for a cathode 40 or an anode 42 tube, are all wetted with an electrolyte, which aids in the ability of the plurality of cathode 40 and anode 42 tubes to react with each other electro-chemically to create an electrical current at the battery terminal ends 30, 32. By way of example only, one type of electrolyte used to wet the outer layers 44 and the bodies 46 is 1.0M LiPF₆ in EC:DEC:EMC=1:1:1.

When the electrodes, the plurality of cathode 40 and anode 42 tubes, are charging or discharging, ions migrate between each of the plurality of cathode tubes 40 and those of the plurality of anode tubes adjacent thereto, with the direction of flow depending on whether charging or discharging is occurring. When the ions move, an electrical charge imbalance is created. The electrons flow across the battery terminals 30, 32 and the electrical circuit connected thereto (not shown) to balance the electrical charge created by the flowing ions.

Returning attention to the current collector pins 50; each 50 has a defined length that extends through at least a portion of each of the bodies 46 in the tubes 40,42. A portion of the current collector pins 50 extends out past the bodies 46 and physically contact one of the two main current collecting plates 34, 36. In the embodiment shown, each of the current collector pins 50 extends out to a distal end 51 with a weld plate 53 attached thereto or formed therewith. In other words, the current collector pins 50 for the plurality of cathode tubes 40 extend out and physically contact the cathode main current collect plate 34, whereas the current collector pins 50 for the plurality of anode tubes 42 extend out and physically contact the anode main current collecting plate 36. The weld plates 53 of the current collector pins 50 may be welded to the cathode 34 and anode 36 main current collect plates, respectively. The current collector pins 50 used with the plurality of cathode tubes 40 are fabricated from a group of materials including aluminum and stainless steel. The current collector pins 50 used with the plurality of anode tubes 42 are fabricated from fabricated from a group of materials including copper and stainless steel.

In the embodiments shown in the Figures, each of the plurality of cathode 40 and anode 42 tubes has a hexagonal cross-sectional shape. This provides maximum surface area contact between the cathodes and anodes with a minimal amount of insulative material 44. As such, a packing factor of the electrodes 40, 42 is maximized, which maximizes the material loading per unit volume. It should be appreciated by those skilled in the art that other cross-sectional shapes may be used.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

I claim:

1. A battery assembly comprising:
a battery case extending between a first case side and a second case side;
an anode main current collecting plate disposed adjacent said first case side;
a cathode main current collecting plate disposed adjacent said second case side;
a pair of terminal ends each electrically connected to said anode and cathode main current collecting plates, respectively;
a plurality of cathode tubes extending between said anode and cathode main current collecting plates; and
a plurality of anode tubes extending between said anode and cathode main current collecting plates, each of the plurality of anode tubes being dispersed amongst said plurality of cathode tubes such that at least one of said plurality of anode tubes is disposed adjacent at least one of said plurality of cathode tubes and at least one of said plurality of cathode tubes is disposed adjacent at least one of said anode tubes, wherein said plurality of anode and cathode tubes react with each other electro-chemically to create an electrical current at said pair of terminal ends.

2. A battery assembly as set forth in claim 1 including a plurality of anode current collector pins, each extending through at least a portion of each of said plurality of anode tubes and out therepast such that each of said plurality of anode current collector pins is fixedly secured to said anode main current collecting plate.

3. A battery assembly as set forth in claim 2 including a plurality of cathode current collector pins, each extending through at least a portion of each of said plurality of cathode tubes and out therepast such that each of said plurality of cathode current collector pins is fixedly secured to said cathode main current collecting plate.

4. A battery assembly as set forth in claim 3 wherein each of said plurality of anode tubes and each of said plurality of cathode tubes includes an electrically insulative outer layer.

5. A battery assembly as set forth in claim 4 wherein each of said plurality of tubes has a hexagonal cross-sectional shape.

6. A battery assembly as set forth in claim 5 wherein each of said plurality of anode current collector pins is welded to said anode main current collecting plate.

7. A battery assembly as set forth in claim 5 wherein each of said plurality of cathode current collector pins is welded to said cathode main current collecting plate.

8. A battery assembly as set forth in claim 5 wherein each of said plurality of cathode tubes is surrounded by a portion of said plurality of anode tubes such that each of said plurality of cathode tubes is spaced apart from every other of said plurality of cathode tubes.

9. A battery assembly as set forth in claim 5 wherein each of said plurality of anode tubes is surrounded by a portion of said plurality of cathode tubes such that each of said plurality of anode tubes is spaced apart from every other of said plurality of anode tubes.

10. An electrode assembly comprising:
an elongated body;
a current collector pin having a defined length, wherein a portion of said defined length extends into said elongated body; and
an insulative outer layer surrounding said elongated body.

11. An electrode assembly as set forth in claim 10 wherein said portion of said current collector pin extends into said elongated body at a center of said elongated body.

12. An electrode assembly as set forth in claim 11 wherein said elongated body has a hexagonal cross section.

13. An electrode assembly as set forth in claim 12 wherein said current collector pin includes a weld plate disposed at a distal end of said current collector pin.
